(19) United States
(12) Patent Application Publication
(10) Pub. No.: US 2014/0244934 A1
(43) Pub. Date: Aug. 28, 2014

(54) STORAGE APPARATUS

(71) Applicant: HITACHI, LTD., Tokyo (JP)

(72) Inventors: Akihiro Mori, Tokyo (JP); Takumi Sano, Tokyo (JP); Shinichi Hiramatsu, Tokyo (JP)

(21) Appl. No.: 14/115,001

(22) PCT Filed: Feb. 25, 2013
(86) PCT No.: PCT/JP2013/054820

§ 371 Date: Oct. 31, 2013

(51) Int. Cl. G06F 12/08

(52) U.S. Cl. CPC G06F 12/0868
USPC 711/126

(57) ABSTRACT

[Object] A storage apparatus capable of preventing degradation of processing performance when transferring data of a record format to a main frame is proposed.

[Solution] When data designated by a read request from a main frame is stored in a cache memory, a transfer control unit refers to internal control information, identifies the length of a key area and the length of a data area of the data designated by the read request, calculates an address of the data, which is designated by the read request, in the cache memory based on the identified length of the key area, the identified length of the data area, and the length of a count area which is a fixed length, and controls processing for collectively transferring the data, which is stored at the calculated address in the cache memory, from the cache memory to a channel adapter.

### TECHNICAL FIELD

The present invention relates to a storage apparatus. Particularly, the invention is suited for use in a storage apparatus for transferring data of a record format to a main frame.

### BACKGROUND ART

Conventionally, a storage apparatus including a disk device for storing data and a controller for reading the data stored in the disk device and transferring it to a main frame executes processing for transferring the data in a record format. The record format is also called a CKD (Count Key and Data) format. This record format (CKD format) is disclosed in, for example, Patent Literature 1.

Patent Literature 1 discloses that data of the record format is composed of a count area (C), a key area (K), and a data area (D). Moreover, the count area stores information indicating the position and length of the relevant record; the key area stores search information for searching data stored in the data area; and the data area stores the main body of the data.

Moreover, it is disclosed regarding the data of the record format that the count area has a fixed length (8 bytes), the key area has a variable length (0 to 255 bytes), and the data area also has a variable length (0 to 56664 bytes), so the data has a variable length as a whole. Then, a storage apparatus designed to execute processing for efficiently transferring such data of the record format to a main frame is disclosed.

### CITATION LIST

### Patent Literature

[Patent Literature 1] Japanese Patent Application Laid-Open (Kokai) Publication No. 2006-190256

### SUMMARY OF INVENTION

### Problems to be Solved by the Invention

Meanwhile, when processing for transferring the data of this record format to the main frame is executed, for example, the following processing is executed. Firstly, the main frame sends a command called a read track command to a storage apparatus. The read track command is a command to issue an instruction to transfer all pieces of data included in a track designated as a read target to the main frame. A track is a storage area unit composed of a plurality of records.

After receiving the read track command from the main frame, the storage apparatus reads data in all records included in the track designated by the read track command from a cache memory in a controller or a disk device connected to the controller and executes processing for transferring the read data within the controller. Then, eventually, the storage apparatus transfers the data, on which the transfer processing has been executed, to the main frame.

Since a record is composed of a count area, a key area, and a data area as described earlier, processing for transferring the count area, the key area, and the data area separately is executed when executing the processing for transferring data of the record format within the controller.

Specifically speaking, on the premise that the controller is provided with at least a cache memory, a transfer control unit including a local memory, and a channel adapter, the controller transfers the count area from the cache memory to the local memory in the transfer control unit (first transfer) and then transfers it from the local memory to the channel adapter (second transfer). Subsequently, the controller transfers it from the channel adapter to the main frame. As a result, the number of times the count area for one record is transferred within the controller is twice.

On the other hand, the controller transfers the key area and the data area respectively from the cache memory to the channel adapter. The reason why the key area and the data area are not transferred from the cache memory to the local memory, but directly transferred to the channel adapter is because the transfer control unit can identify the positions of the key area and the data area in the cache memory by using the count area transferred to the local memory beforehand. Therefore, the number of times the key area and the data area for one record are transferred within the controller is once for each of the key area and the data area, that is, twice in total.

Accordingly, after receiving a read track command from the main frame, the storage apparatus executes the processing for transferring the count area within the controller twice and executes the processing for transferring each of the key area and the data area once before transferring data in one record of the track, which is designated by the read track command, to the main frame. As a result, the transfer processing needs to be executed at least four times.

One track is normally composed of a plurality of records. So, when data of all records included in one track are to be transferred to the main frame, the number of times of transfer becomes a large number. Referring to the above-mentioned example, if n pieces of records exist in one track, the number of times transfer needs to be executed is 4×n times. Furthermore, when all records included in a plurality of tracks are to be transferred, the number of times of transfer further increases. As a result, this causes a problem of increase of overhead and degradation of processing performance of the entire storage apparatus.

The present invention was devised in consideration of the above-described circumstances and suggests a storage apparatus capable of preventing degradation of processing performance when transferring data of the record format to the main frame.

### Means for Solving the Problems

In order to solve the above-described problems, a controller of the present invention includes: a cache memory storing data of the record format; a transfer control unit for controlling processing for transferring the data stored in the cache memory; a channel adapter for receiving the data, which has been transferred by means of the transfer processing by the transfer control unit, and transferring the received data to a main frame; and internal control information including information indicating a length of a key area and a length of a data area of the data stored in the cache memory, and wherein when data designated by a read request from the main frame is stored in the cache memory, the transfer control unit refers to the internal control information, identifies the length of the key area and the length of the data area of the data designated by the read request, calculates an address of the data, which is designated by the read request, in the cache memory based on the identified length of the key area, the identified length of the data area, and a length of the count area, which is a fixed length, and controls processing for transferring the data stored at the calculated address in the cache memory collectively from the cache memory to the channel adapter.

Furthermore, in order to solve the above-described problems, a controller of the present invention includes: a cache memory storing data of the record format; a transfer control unit for controlling processing for transferring the data stored in the cache memory; a channel adapter for receiving the data, which has been transferred by means of the transfer processing by the transfer control unit, and transferring the received data to a main frame; and internal control information including information indicating a length of a key area and a length of a data area of the data stored in the cache memory, and wherein when data of a track designated by a read track command from the main frame is stored in the cache memory, the transfer control unit refers to the internal control information, identifies the length of the key area and the length of the data area of each record for the track designated by the read track command, calculates respective addresses of the count area, the key area, and the data area of the track, which is designated by the read track command, in the cache memory based on the identified length of the key area, the identified length of the data area, and a length of the count area, which is a fixed length, creates a data transfer list, in which the calculated addresses in the cache memory are listed for each record, and controls processing for transferring the data of one track size stored at the addresses in the cache memory collectively from the cache memory to the channel adapter based on the created data transfer list.

By adopting the above-described configuration, the storage apparatus of the present invention can directly transfer data of the record format, which is composed of the count area, the key area, and the data area, not separately, but collectively from the cache memory to the channel adapter. So, while the number of times of transfer conventionally required to transfer one record within the controller before transferring it to the main frame was at least four times in total, it can be reduced to once. Moreover, when n pieces of records are to be transferred, data of n pieces of records can be collectively transferred from the cache memory to the channel adapter in the same manner. Therefore, while the number of times of transfer conventionally required to transfer the n pieces of records within the controller before transferring them to the main frame was at least 4×n times in total, it can be reduced to once.

In other words, the storage apparatus of the present invention can greatly reduce the number of times of data transfer within the controller when transferring data of the record format to the main frame as compared to the conventional number of times of data transfer. Therefore, it is possible to obtain a functional effect of being capable of inhibiting increase of overhead.

### Advantageous Effects of Invention

According to the present invention, it is possible to prevent degradation of processing performance when transferring data of the record format to the main frame.

### BRIEF DESCRIPTION OF DRAWINGS

FIG. 1 is a schematic diagram for explaining the outline of this embodiment.

FIG. 2 is an overall configuration diagram of a storage apparatus.

FIG. 3 is a logical configuration diagram of a logical volume.

FIG. 4 is a logical configuration diagram of internal control information.

FIG. 5 is an example of bitmap information stored as the internal control information.

FIG. 6 is a logical configuration diagram of conventional internal control information.

FIG. 7 is a logical configuration diagram of a data transfer list.

FIG. 8 is a flowchart illustrating internal control information creation processing.

FIG. 9 is a flowchart illustrating read track command response processing.

FIG. 10 is a flowchart illustrating conventional read track command response processing.

FIG. 11 is a flowchart illustrating another read track command response processing.

### DESCRIPTION OF EMBODIMENTS

An embodiment of the present invention will be explained in detail with reference to the relevant drawings.

### (1) Outline of Invention

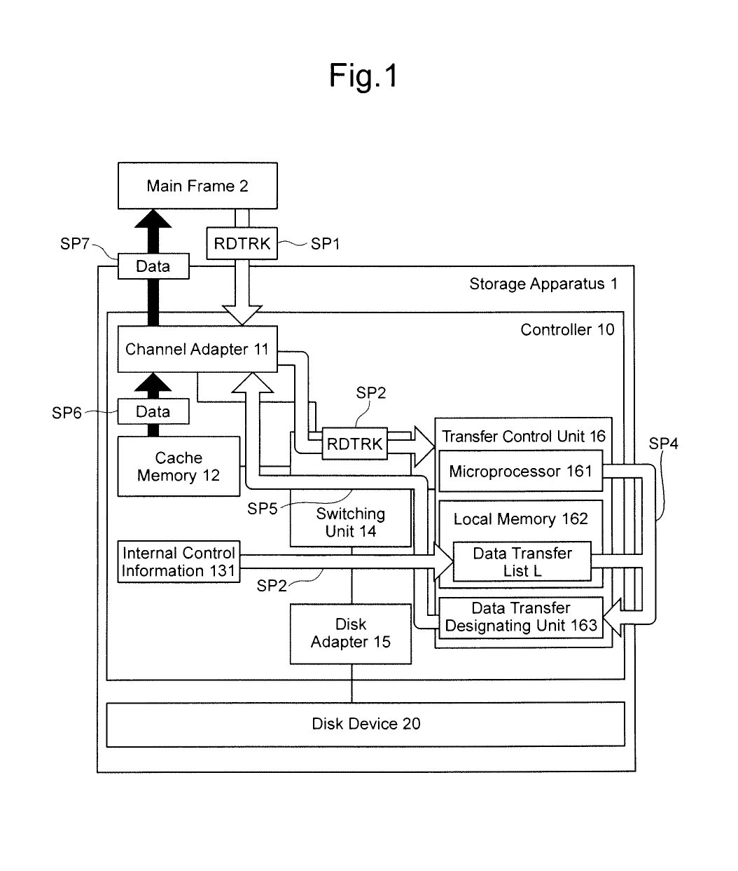

FIG. 1 illustrates a schematic diagram for explaining the outline of this embodiment. When data of a so-called record format or CKD (Count Key and Data) format is to be transferred from a storage apparatus to a main frame in response to a read track command from the main frame, this embodiment is intended to inhibit increase of overhead and prevent degradation of processing performance of the storage apparatus by reducing the number of times the data is transferred within the storage apparatus.

Specifically speaking, a storage apparatus 1 executes the following data transfer processing. When a main frame 2, which is a host system, sends a read track command (RDTRK in the drawing) to the storage apparatus 1 (SP1), a channel adapter 11 sends this read track command via a switching unit 14 to a transfer control unit 16 (SP2).

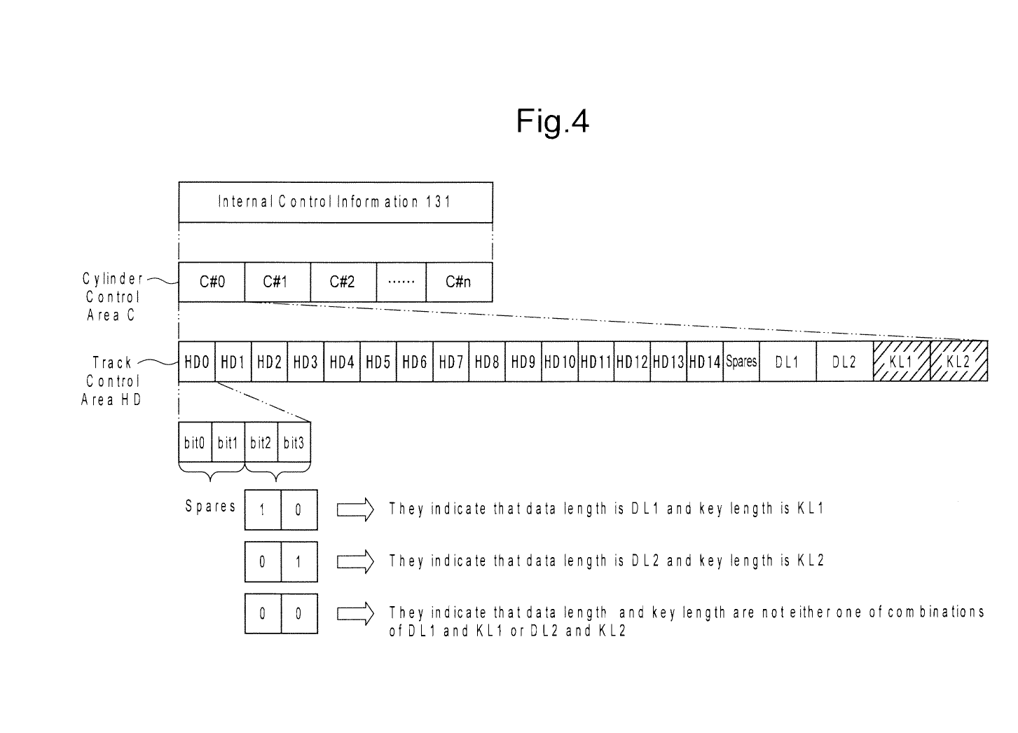

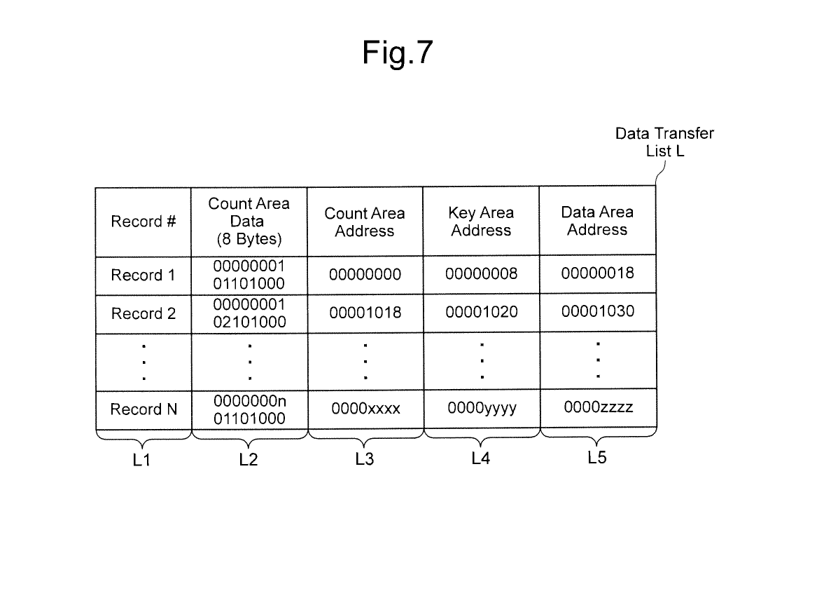

After receiving the read track command, a microprocessor 161 for the transfer control unit 16 creates a data transfer list L in a local memory 162 by referring to internal control information 131 (SP3). The details of the internal control information 131 and the data transfer list L will be described later in detail (FIG. 4 and FIG. 7); however, briefly speaking, the internal control information 131 stores information indicating the lengths of a key area and data area of each record constituting a track. Moreover, the data transfer list L is information indicating a list of addresses, in the cache memory 12, of the count area, the key area, and the data area for each record constituting a track designated by the read track command.

Accordingly, the microprocessor 161 can identify the lengths of the key area and the data area for each record constituting the track designated by the read track command by referring to the internal control information 131. Since the length of the count area is normally 8 bytes and is a fixed length, the microprocessor 161 can identify the respective lengths of the count area, the key area, and the data area for each record of the track designated by the read track command.

Since the read track command includes information for identifying the position of the track which is a read target, the microprocessor 161 can calculate an address, in the cache memory 12, of the count area of a first record of the track, which is designated by the read track command, based on this read track command. Then, the microprocessor 161 can calculate the addresses of the count area, the key area, and the data area in the cache memory 12 based on the address of the count area for the first record and the lengths of the count area, the key area, and the data area. Furthermore, the microprocessor 161 can create the data transfer list L in which the calculated address are listed for each record.

It should be noted that conventionally, control information corresponding to the internal control information 131 stores information indicating the length of the data area, but does not store information indicating the length of the key area. So, it has not been conventionally possible to identify addresses of the count area, the key area, and the data area in the cache memory 12 by referring to the control information.

Next, the microprocessor 161 sends the data transfer list L, which is created in the local memory 162, to a data transfer designating unit 163 (SP4). The data transfer designating unit 163 issues an instruction to the channel adapter 11 to transfer data, which is stored at the address designated by the data transfer list L, from the cache memory 12 to the channel adapter 11 (SP5).

After receiving the instruction from the data transfer designating unit 163, the channel adapter 11 obtains the data stored in the designated address in the cache memory 12 (SP6). According to this embodiment, processing for transferring the data, which is designated by the read track command, within the storage apparatus 1 is executed for the first time in this step SP6.

Then, the channel adapter 11 transfers the data from the cache memory 12 to the main frame 2 (SP7) and terminates the data transfer processing according to this embodiment.

According to this embodiment as described above, the number of times the data is transferred within the storage apparatus 1 in response to the read track command from the main frame 2 can be limited to only once. The details of the storage apparatus 1 according to this embodiment will be explained below with reference to the relevant drawings.

### (2) Overall Configuration

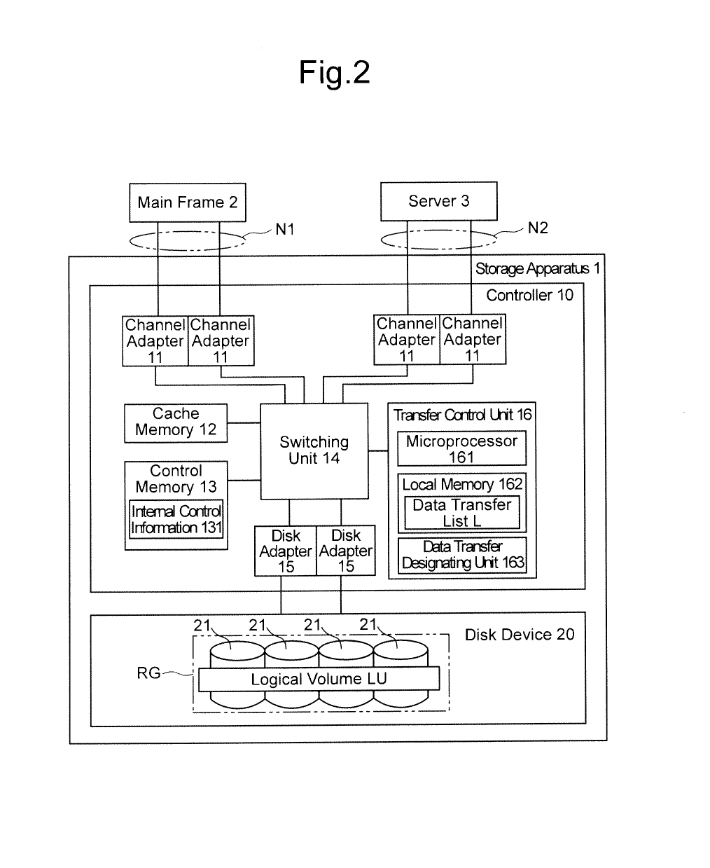

FIG. 2 illustrates an overall configuration of the storage apparatus 1. The storage apparatus 1 is connected to the main frame 2 and a server 3, which are host systems, via communication paths N1 and N2 so that they can communicate with each other. The communication path N1 is a communication path for the main frame and a communication protocol such as FICON (Fibre Connection) or ESCON (Enterprise Systems Connection) is used. Also, the communication path N2 is an open communication path and a communication protocol such as FCP (Fibre Channel Protocol) is used.

Subsequently, an internal configuration of the storage apparatus 1 will be explained. The storage apparatus 1 is composed of a controller 10 and a disk device 20. The controller 10 includes a plurality of channel adapters 11, a cache memory 12, a control memory 13, a switching unit 14, a plurality of disk adapters 15, and a transfer control unit 16; and the disk device 20 includes a plurality of physical disks 21.

The channel adapter 11 is a control circuit composed of, for example, a microprocessor, a memory, a data transfer circuit, and a communications interface which are not illustrated in the drawing. For example, after receiving a read track command from the main frame 2, the channel adapter 11 reads data corresponding to the read track command from the cache memory 12 and sends the read data to the main frame 2.

The cache memory 12 is, for example, an SRAM (Static Random Access Memory) and is a storage medium capable of reading and writing data at high speeds. The cache memory 12 stores data designated by the read track command from the main frame 2 or the server 3.

The control memory 13 is, for example, an SRAM and is a storage medium capable of reading and writing data at high speeds. The control memory 13 stores the internal control information 131. Incidentally, in this example, the above-described configuration is adopted so that the control memory 13 is provided separately from the cache memory 12 and the internal control information 131 is stored in the control memory 13; however, the invention is not limited to this example and one cache memory which integrates the control memory 13 and the cache memory 12 may be provided and the internal control information 131 may be stored in this integrated cache memory. Moreover, the internal control information 131 may be stored in any of storage media such as the cache memory 12, the local memory 162, or a logical volume LU. Particularly, it is possible to secure redundancy by storing the internal control information 131 in the logical volume LU.

The switching unit 14 is a control circuit for connecting the channel adapter 11, the cache memory 12, the control memory 13, the disk adapter 15, and the transfer control unit 16 to each other. The switching unit 14 allows, for example, the channel adapter 11 and the disk adapter 15 to access the cache memory 12, the control memory 13, and the transfer control unit 16.

The disk adapter 15 is a control circuit including, for example, a microprocessor, a memory, a data transfer circuit, and a communications interface which are not illustrated in the drawing, like the channel adapter 11. The disk adapter 15 transfers, for example, data in the cache memory 12 to the disk device 20 (destaging); and on the other hand, the disk adapter 15 transfers data in the disk device 20 to the cache memory 12 (staging).

The transfer control unit 16 is a control circuit in which the microprocessor 161, the local memory 162, and the data transfer designating unit 163 are packaged. The microprocessor 161 is a processor for controlling the operation of the transfer control unit 16 in an integrated manner. The local memory 162 is a storage medium storing the data transfer list L created by the microprocessor 161. The data transfer designating unit 163 is a processor for issuing instructions to the channel adapter 11 to transfer data.

The plurality of physical disks 21 are, for example, FC (Fibre Channel) disks, SCSI (Small Computer System Interface) disks, SATA disks, ATA (AT Attachment) disks, or SAS (Serial Attached SCSI) disks and are storage media capable of storing large-capacity data. In this example, one RAID (Redundant Array Independent Disks) group RG is set to physical storage areas which the plurality of physical disks 21 have; and one logical volume LU is set to logical storage areas in this RAID group RG. Incidentally, this example shows the configuration in which only one RAID group RG and one logical volume LU are set; however, the configuration is not limited to this example and a plurality of RAID groups RG and logical volumes LU may be set.

### (3) Details of Constituent Elements

### (3-1) Configuration of Logical Volume

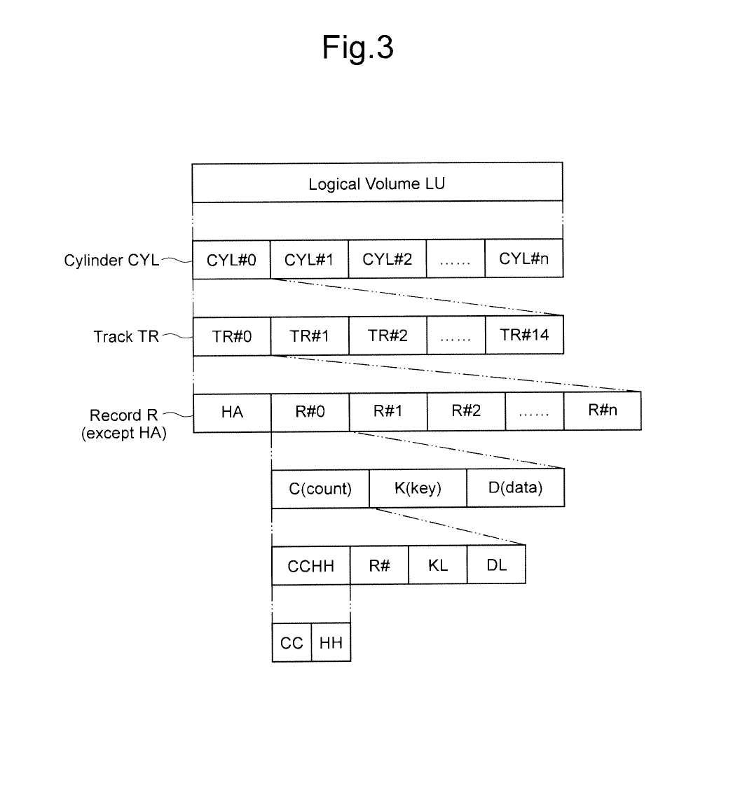

FIG. 3 illustrates a logical configuration of a logical volume LU. The logical volume LU is composed of storage areas called a plurality of cylinders CYL (CYL#0 to CYL#n in the drawing) and each cylinder CYL is composed of storage areas called a plurality of tracks TR (TR#0 to TR#14 in the drawing). It should be noted that generally the number of tracks TR included in one cylinder CYL is fifteen. Accordingly, a storage area of the logical volume LU is divided into respective cylinders CYL and a storage area of one cylinder CYL is divided into respective tracks TR.

Furthermore, each track TR is composed of storage areas called a home address HA (Home Address) and a plurality of records R (HA and R#0 to R#n in the drawing). In this way, a storage area of each track TR is divided into respective records R. Incidentally, the home address HA is a storage area located at a top of each track TR and the home address HA stores control information for the track TR.

Furthermore, each record R is composed of storage areas called count area C, key area K, and data area D (C (count), K (key), and D (data) in the drawing). The count area C stores positional information about the record R, the key area K stores search information for searching data of the data area D, and the data area D stores a main body of the data.

As further explanation of the count area C, the count area C is composed of storage areas storing a cylinder track number CCHH, a record number R#, a key length KL, and a data length DL; and the cylinder track number CCHH is composed of storage areas storing a cylinder number CC and a track number HH. Therefore, the position of one track TR in the logical volume LU can be identified by referring to the cylinder number CC and the track number HH which are stored in the count area C. Furthermore, the position of one record in one identified track TR can be identified by referring to the record number R#. Since a standard value of the length of the count area C is 8 bytes, which is a fixed length, the positions of the key area K and the data area D within one identified record can be identified by referring to the key length KL and the data length DL. In other words, the position of the data stored in one record within the logical volume LU can be identified by referring to the count area C.

Incidentally, a storage area in the cache memory 12 is also divided so that the divided areas correspond to the configuration of the logical volume LU as shown in FIG. 3.

### (3-2) Configuration of Internal Control Information

FIG. 4 illustrates a logical configuration of the internal control information 131. The internal control information 131 is composed of a plurality of cylinder control areas C (C#0 to C#n in the drawing). These cylinder control areas C correspond to the cylinders CYL in the logical volume LU as explained with reference to FIG. 3. For example, control information corresponding to the cylinder CYL#0 in the logical volume LU is stored in a cylinder control area C#0 in the internal control information 131.

Each cylinder control area C is composed of a plurality of track control areas HD (HD0 to HD14 in the drawing), data length storage areas DL1 and DL2, and key length storage areas KL1 and KL2. The track control areas HD corresponds to the tracks TR in the logical volume LU explained with reference to FIG. 3. For example, control information corresponding to track TR#0 in the logical volume LU is stored in a track control area HD0 in the internal control information 131.

Each track control area HD stores information indicating the size of each record R constituting the track TR. Specifically speaking, 4 bits are assigned to each track control area HD; and if bit 2 stores 1 and bit 3 stores 0 (10 in the drawing), 10 indicates that they are predetermined first data length and first key length; if bit 2 stores 0 and bit 3 stores 1 (01 in the drawing), 01 indicates that they are predetermined second data length and second key length; and both bits 2 and 3 store 0 (00 in the drawing), 00 indicates that they are neither the first data length and the first key length nor the second data length and the second key length. Incidentally, the data length and the key length herein used mean the lengths of the data area D and the key area K which constitute the record R. Also, bits 0 and 1 are spares and not used.

The data length storage area DL1 stores information about the first data length and the data length storage area DL2 stores information about the second data length. Moreover, the key length storage area KL1 stores the first key length and the key length storage area KL2 stores the second key length.

In this way, the cylinder control areas C are created in the internal control information 131 so that they correspond to the cylinders CYL constituting the logical volume LU; and the plurality of track control areas HD, the data length storage areas DL1 and D2, and the key length storage areas KL1 and KL2 are created in the cylinder control area C. Each track control area HD stores information about the length of the data area D (DL1 or DL2) and information about the length of the key area K (KL1 or KL2). Accordingly, the data length and the key length of each record R constituting the track TR can be identified without referring to the count area C by referring to this internal control information 131; and since the length of the count area C is 8 bytes, which is a fixed length, it is possible to identify the size of the record R as a result.

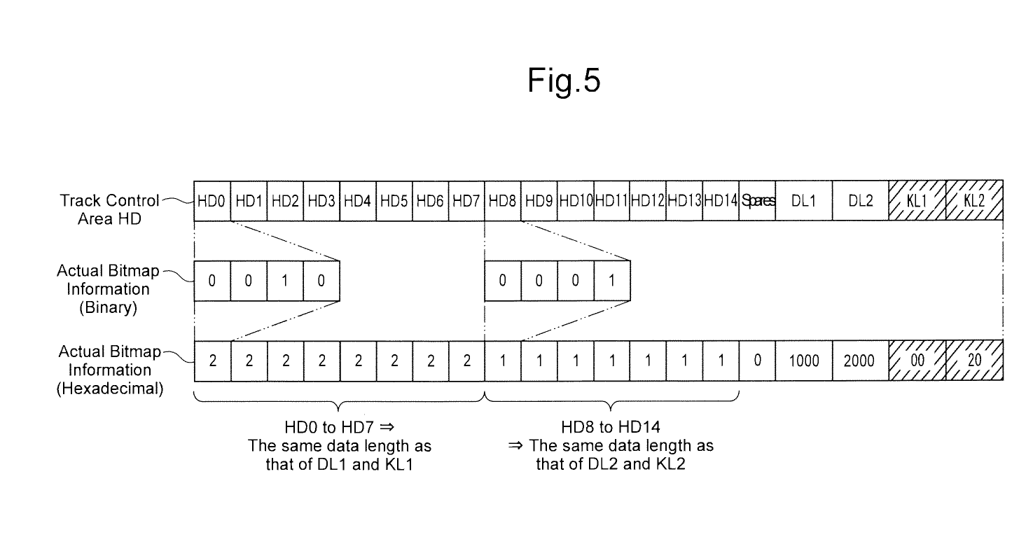

FIG. 5 illustrates an example of bitmap information actually stored as the internal control information 131. As shown in FIG. 5, the internal control information 131 actually stores the bitmap information such as “2222222211111110100020000020” expressed in hexadecimal notation. The first eight “2's” are “0010” in binary notation, among which low-order 2 bits “10” indicate that the data length and the key length are the first data length DL1 and the first key length KL1. So, this example shows that the data length and the key length of tracks TR#0 to #7 are the first data length DL1 and the key length KL1.

Moreover, seven “1's” following “2's” are “0001” in binary notation, among which low-order 2 bits “01” indicate that the data length and the key length are the second data length DL2 and the second key length KL2. So, this example shows that the data length and the key length of tracks TR#8 to #14 are the second data length DL2 and the key length KL2.

Furthermore, the data length storage areas DL1 and DL2 store “1000” and “2000” in hexadecimal notation, which are 4096 and 8192 in decimal notation. Therefore, this indicates that the first data length DL1 is 4096 bytes and the second data length DL2 is 8192 bytes. Also, the key length storage areas KL1 and KL2 store “00” and “20” in hexadecimal notation, which are 0 and 32 in decimal notation. Therefore, this example shows that the first key length KL1 is 0 byte and the second key length KL2 is 32 bytes.

Accordingly, it is possible to identify, by referring to this internal control information 131, that the data length in each record of the tracks TR#0 to #7 is 4096 bytes and the key length is 0 byte. It is also possible to identify that the data length in each track of the tracks R#8 to #14 is 8192 bytes and the key length 32 bytes.

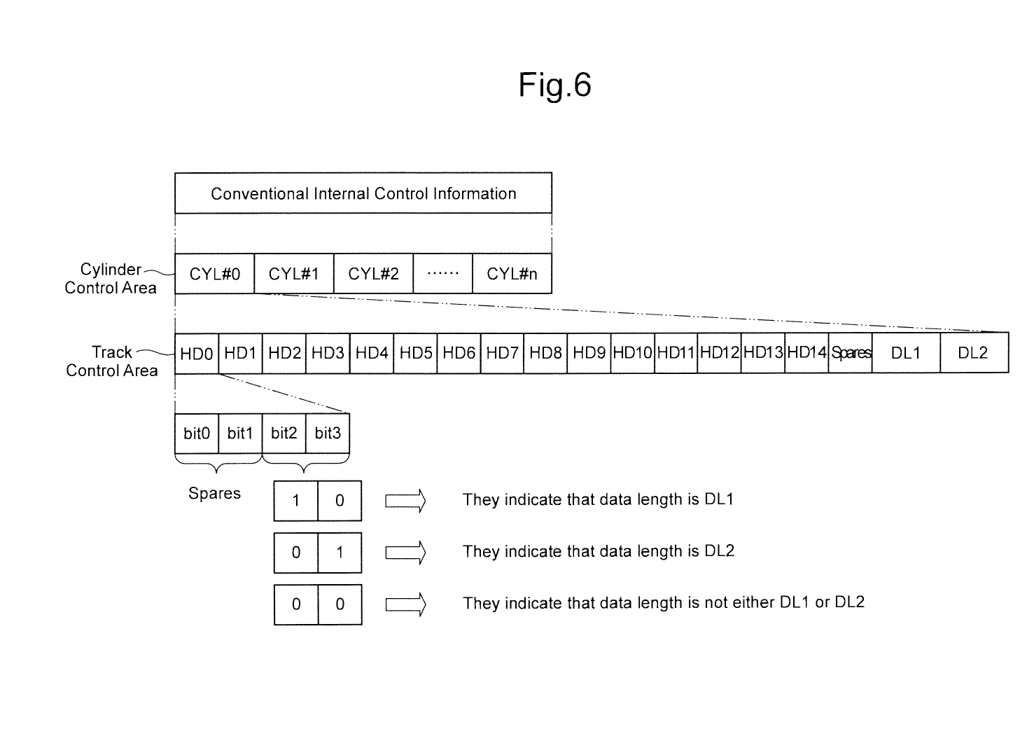

FIG. 6 illustrates a logical configuration of conventional internal control information as a comparative example for the internal control information 131 according to this embodiment which has been explained above. The conventional internal control information is different from the internal control information 131 according to this embodiment because the key length storage areas KL1 and KL2 are not secured in the conventional internal control information. Since these key length storage areas KL1 and KL2 are not secured, the key length in the relevant record cannot be identified even by referring to the conventional internal control information. As a result, the size of the record R cannot be identified unlike this embodiment.

FIG. 7 illustrates a logical configuration of the data transfer list L. The data transfer list L is information which is created by the microprocessor 161 with respect to each record and stored in the local memory 162 when a read track command is issued from the main frame 2 to the storage apparatus 1. The data transfer list L stores addresses of the count area C, the key area K, and the data area D in the cache memory 12. So, the transfer control unit 16 can identify an address of data to be transferred from the cache memory 12 to the channel adapter 11 by referring to this data transfer list L.

The data transfer list L is constituted from a record number area L1, a count area data area L2, a count area address area L3, a key area address area L4, and a data area address area L5. The record number area L1 stores information about a record number. Moreover, the count area data area L2 stores information about an 8-byte fixed length. Specifically speaking, the count area data area L2 stores information about the cylinder track number CCHH, the record number R#, the key length KL, and the data length DL. Incidentally, the microprocessor 161 calculates the cylinder track number CCHH based on the read track command, calculates the record number R# by setting the first number as 1 and then sequentially advancing the number, and calculates the key length KL and the data length DL based on the internal control information 131.

Furthermore, the count area address area L3 stores an address of the count area C in the cache memory 12; the key area address area L4 stores an address of the key area K in the cache memory 12; and the data area address area L5 stores an address of the data area D in the cache memory 12.

When creating this data transfer list L, the microprocessor 161 stores the number of records, which constitute a track designated by the read track command, in the record number area L1. Alternatively, the microprocessor 161 may store the maximum number of records constituting one track in the record number area L1 in advance. Then, the microprocessor 161 creates the count area C of each record based on the read track command and the internal control information 131 and stores the created count area C in the count area data area L2. Then, the microprocessor 161 firstly stores addresses of the count area C, the key area K, and the data area D in the cache memory 12 in the respective areas L3 to L5, sequentially starting from record 1. Specifically speaking, the microprocessor 161 calculates and stores the address of the count area C for the record 1 based on the read track command. Then, the microprocessor 161 calculates and stores the addresses of the key area K and the data area D for the record 1 based on the address of the count area C for the record 1 and the key length and the data length stored in the internal control information 131. The microprocessor 161 can create the data transfer list L by calculating and storing addresses of the count area C, the key area K, and the data area D for record 2 and subsequent records in the same manner.

### (4) Flowcharts

### (4-1) Internal Control Information Creation Processing

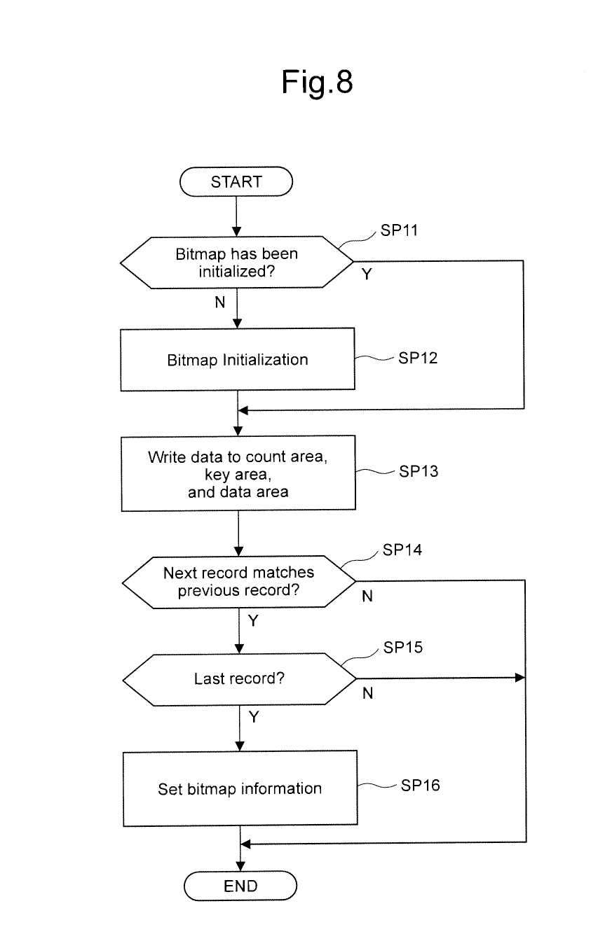

FIG. 8 illustrates a processing sequence for internal control information creation processing. This internal control information creation processing is executed by the microprocessor 161 for the transfer control unit 16 as triggered by the receipt of format write, which is issued from the main frame 2, by the storage apparatus 1. For the sake of convenience in explanation, the transfer control unit 16 will be described as a processing subject.

Firstly, after receiving the format write from the main frame 2, the transfer control unit 16 refers to the internal control information 131 corresponding to a track designated by the format write and judges whether a bitmap has been initialized or not (SP11).

If the transfer control unit 16 obtains an affirmative result for this judgment, it proceeds to step SP13. On the other hand, if the transfer control unit 16 obtains a negative result for this judgment, it initializes the bitmap stored as the internal control information 131 (SP12).

For example, if the transfer control unit 16 intends to execute the format write on the track TR#0 (FIG. 3) when initializing the bitmap, the internal control information 131 corresponding to the track TR#0 is the track control area HD0 (FIG. 4) and, therefore, the transfer control unit 16 initializes the bitmap stored in this track control area HD0.

Then, the transfer control unit 16 writes data to each of the count area C, the key area K, and the data area D for each record of the track to which it intends to execute the format write (SP13). Incidentally, when this happens, information indicating the cylinder track number CCHH, the record number R#, the key length KL (such as KL1), and the data length DL (such as DL1) is written to the count area C. Moreover, so-called 0 data is written to the key area D and the data area D.

The transfer control unit 16 judges whether the record length of the next record matches the record length of the previous record or not (that is, whether they have the same length or not), with respect to each record of the track on which the format write has been executed (SP14). If the transfer control unit 16 obtains a negative result for this judgment, this means that the respective record lengths are not the same length; so, the transfer control unit 16 determines that the internal control information 131 cannot be created, and then the transfer control unit 16 terminates this processing. On the other hand, if the transfer control unit 16 obtains an affirmative result for the above judgment, it judges whether the next record is the last record or not (SP15).

If the transfer control unit 16 obtains a negative result for this judgment, it terminates this processing (returns to SP14). On the other hand, if the transfer control unit 16 obtains an affirmative result for this judgment, it sets the bitmap information to the internal control information 131 corresponding to the track on which the format write has been executed (SP16); and the transfer control unit 16 terminates this processing.

### (4-2) Read Track Command Response Processing

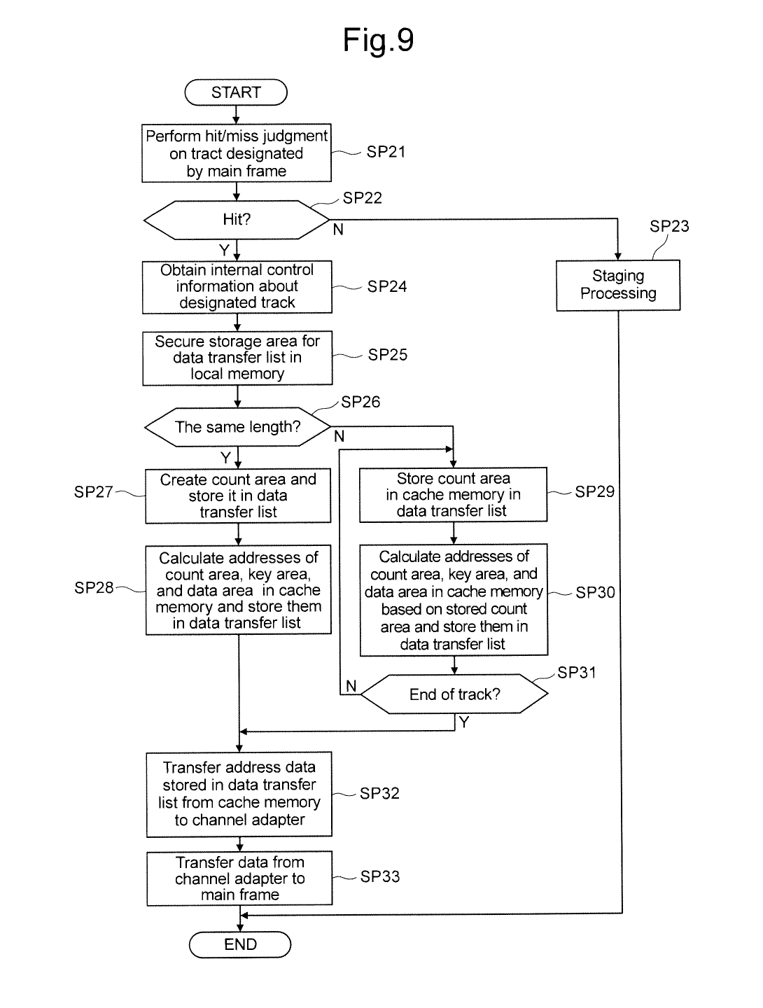

FIG. 9 illustrates a processing sequence for read track command response processing. This read track command response processing is executed by the microprocessor 161 for the transfer control unit 16 as triggered by the receipt of a read track command, which is issued from the main frame 2, by the storage apparatus 1. For the sake of convenience in explanation, the transfer control unit 16 will be described as a processing subject.

Firstly, after receiving the read track command from the main frame 2, the transfer control unit 16 performs a hit/miss judgment to check whether a track designated by the read track command is stored in the cache memory 12 or not (SP21). Then, the transfer control unit 16 judges to check whether the result is a hit judgment or not (SP22).

Incidentally, the read track command from the main frame 2 includes the cylinder track number CCHH as information for identifying the track which is a read target. So, the transfer control unit 16 performs the hit/miss judgment by searching data in the cache memory 12 based on this cylinder track number CCHH.

If the transfer control unit 16 obtains a negative judgment result in step SP22, it executes staging processing (SP23) and terminates this read track command response processing. Incidentally, if it actually is a miss judgment, the transfer control unit 16 notifies the main frame 2 of suspension of the response processing before the staging processing and then notifies the main frame 2 of resumption of the response processing after the staging processing. So, after receiving the notice of resumption of the response processing, the main frame 2 sends the read track command again to the storage apparatus 1.

On the other hand, if the transfer control unit 16 obtains an affirmative judgment result in step SP22, it obtains the internal control information 131 about the track designated by the read track command (SP24). Then, the transfer control unit 16 secures a storage area for the data transfer list L in the local memory 162 (SP25).

The transfer control unit 16 refers to the internal control information 131 and judges whether the lengths of all records constituting the track designated by the read track command are the same or not (SP26). Incidentally, if the length of each record is the same, addresses of the count area C, the key area K, and the data area D in the cache memory 12 for all the records included in the designated track can be stored in the data transfer list L. On the other hand, if the length of each record is not the same, it is necessary to read the count area C of one record of the designated track once and obtain the key length and the data length. Therefore, in order to judge this, the transfer control unit 16 judges whether the length of each record is the same or not, by referring to the internal control information 131.

If the transfer control unit 16 obtains an affirmative judgment result in step SP26, it creates the count area C and stores it in the data transfer list L based on the cylinder track number CCHH included in the read track command and the key length and the data length which are included in the internal control information 131 (SP27).

Then, the transfer control unit 16 calculates an address, in the cache memory 12, of a first record of the track designated by the read track command based on the cylinder track number CCHH included in the read track command. Then, the transfer control unit 16 stores this address as an address of the first count area C in the data transfer list L. Subsequently, the transfer control unit 16 calculates addresses of the key area K and the data area D for the first record based on the address of this count area C and the key length and the data length of the internal control information 131 and stores the calculated addresses in the data transfer list L. The transfer control unit 16 calculates addresses of the next record in the same manner and thereby stores the addresses of the count area C, the key area K, and the data area D in the cache memory 12 for all records of the track, which is designated by the read track command, in the data transfer list L (SP28).

On the other hand, if the transfer control unit 16 obtains a negative judgment result in step SP26, it obtains data of the count area C from the cache memory 12 and stores the obtained data of the count area C in the data transfer list L (SP29). Then, the transfer control unit 16 calculates addresses of the count area C, the key area K, and the data area D in the cache memory 12 for one record included in the track designated by the read track command based on the data of the count area C and stores the calculated addresses in the data transfer list L (SP30).

After executing the processing of step SP30, the transfer control unit 16 judges whether the execution of the processing has reached the end of the track and has been terminated or not (SP31). If the transfer control unit 16 obtains a negative result for this judgment, it calculates addresses of the count area C, the key area K, and the data area D in the cache memory 12 for the next record in the same manner and stores the calculated addresses in the data transfer list L. On the other hand, If the transfer control unit 16 obtains an affirmative result for the above judgment, it proceeds to step SP32.

The transfer control unit 16 issues an instruction to the channel adapter 11 to transfer all pieces of data in the track designated by the read track command collectively from the cache memory 12 to the channel adapter 11 based on the data transfer list L (SP32). Then, the transfer control unit 16 issues an instruction to the channel adapter 11 to transfer the data, which has been transferred to the channel adapter 11, to the main frame 2 (SP33) and then terminates this read track command response processing.

### (4-3) Conventional Read Track Command Response Processing

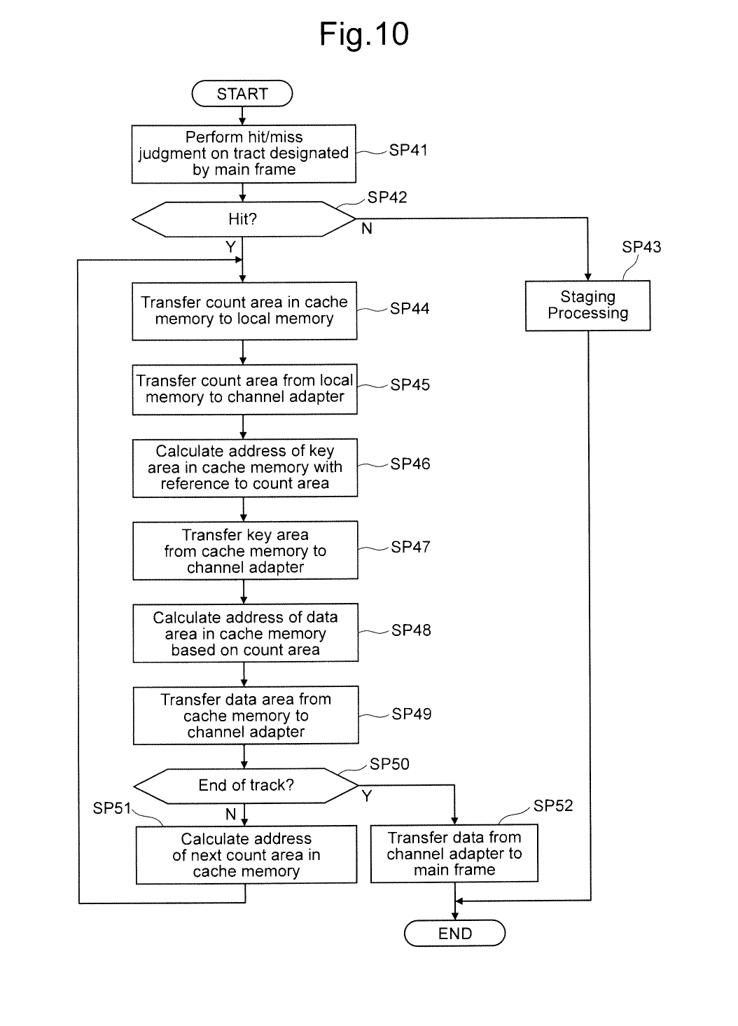

FIG. 10 illustrates a processing sequence for conventional read track command response processing as a comparative example for the read track command response processing (FIG. 9) according to this embodiment. Incidentally, the microprocessor 161 for the transfer control unit 16 executes the read track command response processing illustrated in FIG. 9; however, the following explanation will be given about processing to be executed in a case assuming that the storage apparatus 1 according to this embodiment executes the conventional read track command response processing. Therefore, for the sake of convenience in explanation, the transfer control unit 16 will be described as a processing subject.

Processing from step SP41 to SP43 is the same as the read track command response processing according to this embodiment explained with reference to FIG. 9. Specifically speaking, after receiving a read track command from the main frame 2, the transfer control unit 16 performs a hit/miss judgment (SP41 and SP42); and if it is determined to be a miss, the transfer control unit 16 executes staging processing (SP43) and terminates this processing.

On the other hand, if the transfer control unit 16 determines in the judgment of step SP42 that it is a hit, it transfers data of the count area C in the cache memory 12 to the local memory 162 (SP44). Then, the transfer control unit 16 transfers the data of the count area C from the local memory 162 to the channel adapter 11 (SP45). Accordingly, the transfer control unit 16 executes the processing for transferring the count area C twice in total in steps SP44 and SP45.

Subsequently, the transfer control unit 16 refers to the count area C transferred to the local memory 162, that is, the key length KL included in the count area C, and calculates an address of the key area K in the cache memory 12 (SP46). Then, the transfer control unit 16 issues an instruction to the channel adapter 11 to transfer the key area K from the cache memory 12 to the channel adapter 11 by designating the key length KL and the address of the key area Kin the cache memory 12 (SP47). Therefore, the transfer control unit 16 executes the processing for transferring the key area once in steps SP46 and SP47.

Subsequently, the transfer control unit 16 refers to the count area C stored in the local memory 162, that is, the data length DL included in the count area C, and calculates an address of the data area D in the cache memory 12 (SP48). Then, the transfer control unit 16 issues an instruction to the channel adapter 11 to transfer the data area D from the cache memory 12 to the channel adapter 11 by designating the data length DL and the address of the data area D in the cache memory 12 (SP49). Therefore, the transfer control unit 16 executes the processing for transferring the data area D once in steps SP48 and SP49.

The transfer control unit 16 has executed the processing for transferring the count area C, the key area K, and the data area D separately to the channel adapter 11. The number of times of transfer is four times in total. Then, the transfer control unit 16 judges whether the execution of the processing has reached the end of the track and has been terminated or not (SP50). If the transfer control unit 16 obtains a negative result for this judgment, it executes the processing for transferring the count area C, the key area K, and the data area D for the next record separately to the channel adapter 11 in the same manner. So, if the number of records is n pieces, the transfer processing will be executed 4×n times.

On the other hand, if the transfer control unit 16 obtains an affirmative judgment result in step SP50, it transfers the data of one or more records, on which the processing for transferring the data to the channel adapter 11 has been executed, from the channel adapter 11 to the main frame 2 (SP52) and then terminates this conventional read track command response processing.

### (5) Advantageous Effects of this Embodiment

When the processing for transferring data of the record format is to be executed within the storage apparatus 1 in response to a read track command from the main frame 2, the storage apparatus 1 according to this embodiment as described above is designed to not execute the processing for transferring the count area C, the key area K, and the data area D separately, but to calculate respective addresses of the count area C, the key area K, and the data area D in the cache memory 12 and executes the processing for transferring the data collectively from the cache memory 12 to the channel adapter 11. Accordingly, the number of times data is transferred within the storage apparatus 1 can be reduced significantly as compared to the conventional case. Therefore, it is possible to inhibit increase of overhead and prevent degradation of processing performance of the entire storage apparatus 1.

### (6) Another Embodiment

The read track command response processing (FIG. 9) according to this embodiment is designed to create the data transfer list L and execute the processing for transferring all pieces of data designated by the read track command collectively from the cache memory 12 to the channel adapter 11 based on the created data transfer list L. However, the present invention is not limited to this embodiment and the data designated by the read track command may be transferred collectively to the channel adapter 11 without creating the data transfer list L. The details of another read track command response processing will be explained below with reference to the relevant drawing.

### (6-1) Another Read Track Command Response Processing

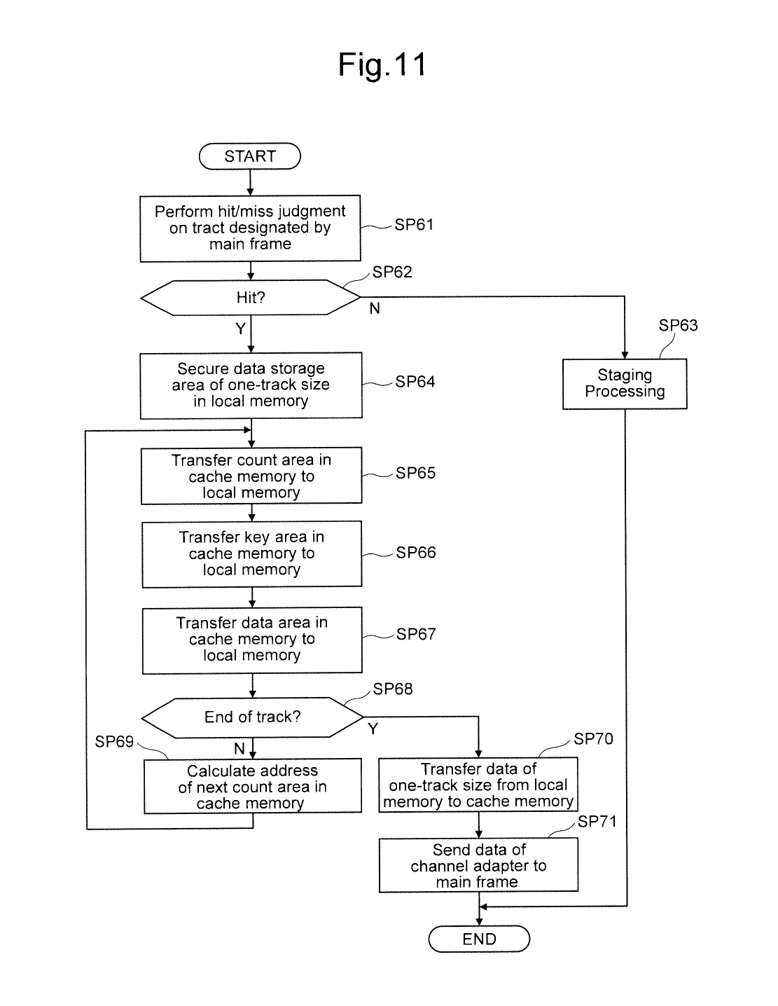

FIG. 11 illustrates a processing sequence for another read track command response processing. This another read track command response processing is executed by the microprocessor 161 for the transfer control unit 16 as triggered by the receipt of a read track command, which is issued from the main frame 2, by the storage apparatus 1. For the sake of convenience in explanation, the transfer control unit 16 will be described as a processing subject.

Processing from step SP61 to SP63 is the same as the read track command response processing according to this embodiment explained with reference to FIG. 9. Specifically speaking, after receiving the read track command from the main frame 2, the transfer control unit 16 performs a hit/miss judgment (SP61 and SP62); and if the transfer control unit 16 determines that it is a miss, it executes staging processing (SP63) and terminates this processing.

On the other hand, if the transfer control unit 16 determines in the judgment of step SP62 that it is a hit, it secures a data storage area of one track size as designated by the read track command in the local memory 162 (SP64).

Then, the transfer control unit 16 transfers the count area C in the cache memory 12 from the cache memory 12 to the local memory 162 and stores the count area C in the local memory 162 (SP65). The same processing is executed with respect to the key area K and the data area D. The transfer control unit 16 transfers the key area K and the data area D in the cache memory 12 from the cache memory 12 to the local memory 162 and stores the key area K and the data area D in the local memory 162 (SP66 and SP67).

The transfer control unit 16 judges whether or not the execution of the processing has reached the end of the track and has been terminated (SP68). If the transfer control unit 16 obtains a negative result for this judgment, it calculates an address of the next count area C in the cache memory 12 (SP69). Subsequently, as described above, the transfer control unit 16 executes processing for transferring the next count area C from the cache memory 12 to the local memory 162 and then transferring the next key area K and the next data area D in the same manner from the cache memory 12 to the local memory 162 until the end of the relevant track.

On the other hand, if the transfer control unit 16 obtains an affirmative judgment result in step SP68, this means that data of one track size is stored in the local memory 162; and the transfer control unit 16 transfers the data of one track size stored in the local memory 162 collectively to the cache memory 12 (SP70).

Then, the transfer control unit 16 issues an instruction to the channel adapter 11 to transfer the data to the main frame 2 (SP71) and terminates this another read track command response processing.

### (6-2) Advantageous Effects of Another Embodiment

When the storage apparatus 1 according to another embodiment is used as described above, it is possible to transfer data of one track size collectively to the channel adapter 11 without preparing special control information such as the internal control information 131 and the data transfer list L. The number of times of transfer within the controller 10 is the same as that of the conventional case; however, since data can be transferred collectively from the local memory 162 to the channel adapter 11, it is possible to enhance a transfer speed as compared to the conventional case which results in a paper-out transfer.

### REFERENCE SIGNS LIST

1 storage apparatus
10 controller
11 channel adapter
12 cache memory
13 control memory
131 internal control information
16 transfer control unit
161 microprocessor
162 local memory
163 data transfer designating unit
2 main frame
3 server

1. (canceled)

2. A storage apparatus for executing processing for transferring data of a record format composed of a count area, a key area, and a data area in response to a read request from a main frame,
the storage apparatus comprising a controller,
wherein the controller includes:
a cache memory storing the data of the record format;
a transfer control unit for controlling the processing for transferring data stored in the cache memory;
a channel adapter for transferring the data, which has been transferred under control of the transfer control unit, to the main frame; and
internal control information including information indicating a length of the key area and a length of the data area of the data stored in the cache memory, and
wherein when data designated by the read request from the main frame is stored in the cache memory, the transfer control unit refers to the internal control information, identifies the length of the key area and the length of the data area of the data designated by the read request, calculates an address of the data, which is designated by the read request, in the cache memory based on the identified length of the key area, the identified length of the data area, and a length of the count area, which is a fixed length, and controls processing for transferring the data stored at the calculated address in the cache memory collectively from the cache memory to the channel adapter;
wherein when the data designated by the read request from the main frame is stored in the cache memory, the transfer control unit refers to the internal control information, identifies the length of the key area and the length of the data area of the data designated by the read request, calculates respective addresses of the count area, the key area, and the data area of the data, which is designated by the read request, in the cache memory based on the identified length of the key area, the identified length of the data area, and a length of the count area, which is a fixed length, creates a data transfer list, in which the calculated addresses are listed for each record, and controls processing for transferring the data stored at the addresses in the cache memory collectively from the cache memory to the channel adapter based on the created data transfer list.

3. The storage apparatus according to claim 2, wherein the transfer control unit stores an address, which is included in the read request, in the data transfer list as an address of the count area for a first record of the data designated by the read request, calculates addresses of the key area and the data area for the first record based on the identified length of the key area and the identified length of the data area and stores the calculated addresses in the data transfer list; and regarding addresses of count areas, key areas, and data areas for a next record to a last record, the transfer control unit calculates the addresses based on the addresses of the count area, the key area, and the data area for the first record and the respective identified lengths of the count area, the key area, and the data area and stores the calculated addresses in the data transfer list, thereby creating the data transfer list.

4-6. (canceled)

7. A storage apparatus for executing processing for transferring data of a record format composed of a count area, a key area, and a data area in response to a read track command from a main frame,
the storage apparatus comprising a controller,
wherein the controller includes:
a cache memory storing the data of the record format;
a transfer control unit for controlling the processing for transferring data stored in the cache memory;
a channel adapter for transferring the data, which has been transferred under control of the transfer control unit, to the main frame; and
internal control information including information indicating a length of the key area and a length of the data area of the data stored in the cache memory, and
wherein when data of a track designated by the read track command from the main frame is stored in the cache memory, the transfer control unit refers to the internal control information, identifies the length of the key area and the length of the data area of each record of the track designated by the read track command, calculates respective addresses of the count area, the key area, and the data area of the track, which is designated by the read track command, in the cache memory based on the identified length of the key area, the identified length of the data area, and a length of the count area, which is a fixed length, creates a data transfer list, in which the calculated addresses in the cache memory are listed for each record, and controls processing for transferring the data of one track size stored at the addresses in the cache memory collectively from the cache memory to the channel adapter based on the created data transfer list.
